(19) United States
(12) Patent Application Publication
(10) Pub. No.: US 2006/0097888 A1
(43) Pub. Date: May 11, 2006

(54) High intensity plastic reflective plates for houses, signs, roads and vehicles

(76) Inventor: Morgan U. Omoregbee, Jacksonville, FL (US)

Correspondence Address: MORGAN U. OMOREGBEE;PEOPLE SAFETY, INC., P.O. BOX 7430, JACKSONVILLE, FL, 32238, US

(21) Appl. No.: 10/982,161

(22) Filed: Nov. 5, 2004

(51) Int. Cl. G08B 5/36

(52) U.S. Cl. 340/815.47

(57) ABSTRACT

A high intensity, plastic reflective plate is particularly useful for house numbers, vehicle license plates and road signs distance visibility. The multi-functionality of the plate system enables for a one-sided installation capability, two-sided horizontal and vertical capability installations. An enhanced distance visibility is greatly improved from different light sources including outside light of the house, street lights and vehicle lights. Installations are to be made on the front wall close to the entrance of the house, mailbox posts, road posts and the license plate positions of any vehicle. The basic reflector plate system is comprised of a high intensity plastic reflector bound or welded together with plastic PVC or ALUMINUM serving as a backing. It is also comprised of non-reflective vinyl material used for lettering and numbering.

### BACKGROUND

I. Field of the Invention

This invention relates to reflective displays, and more specifically to a distance illumination capability for reflective visibility. More particularly, this invention is directed toward a combination of house and vehicle number identifications, as well as road distance direction. For example, when a ray of light reflects on the plastic reflector, it enables the visibility of the numbers and letters which are laminated or pre-pressed onto the high intensity plastic reflector.

II. Description of the Related Art

House numbers, for example, are generally not uniformly made to provide standard identification and visibility with a minimum amount of light. This does not provide easy identification and location for emergency personnel for immediate attention to victims of any kind. This problem is further exacerbated by the increasing volume calls that are made to rescue police and other emergency personnel. As the difficulty of locating a particular address persists, so does the risk to ones life.

Another problem is related to the identification of a particular license plate from a distance, especially at night. License plates are made to illuminate with light directed at them. Also, the rear light located above the license plate may not be sufficient for easy and proper identification of a particular vehicle's license plate. The purpose therefore of this invention is to increase and improve the distance visibility of license plates.

### BRIEF SUMMARY OF THE INVENTION

Generally, this invention relates to a reflective display of numbers and letters from a distance. In one aspect, the invention is believed to provide easy identification and location of house addresses and numbers. A one-sided wall-mounted high intensity plastic reflector plate with vinyl numbers and letters laminated onto it provided clear visibility with the outside light of the house directed towards it. Visibility is also made possible from other light sources, such as street and vehicle lights.

In another embodiment of the present invention, the plate is made with pre-pressed vehicle numbers and letters mounted on the rear and front portion of the vehicle license plate. In one aspect, the horizontal and vertical two-sided reflective plates provide for more two-directional distance identification of a particular address when mounted on the post or corner of a building. In another respect, the reflective plate provided a more visible direction for drivers on the highway or local streets.

The above summary of the present invention is not intended to describe each illustrated embodiment of the invention. The figures and descriptions following the text more particularly exemplify these embodiments.

### DRAWINGS

The basic description of this invention starts with an illumination system for a reflective display which considers the following detailed descriptions of various embodiments of the invention in connection with the accompanying drawings.

FIG. 1: BASIC REFLECTOR DISPLAY SYSTEM

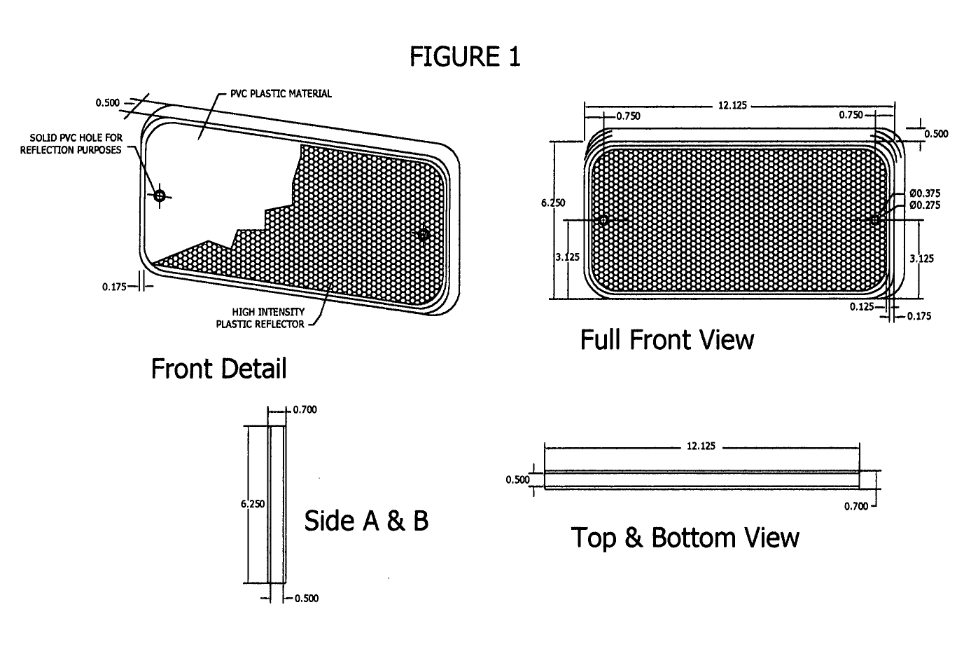

This figure illustrates a basic display system which shows the plastic PVC material bound together with a high intensity plastic reflector sheet with two solid mounting holes for reflective purposes and installations

FIG. 2: PLASTIC FRONT MOUNTED REFLECTOR PLATE

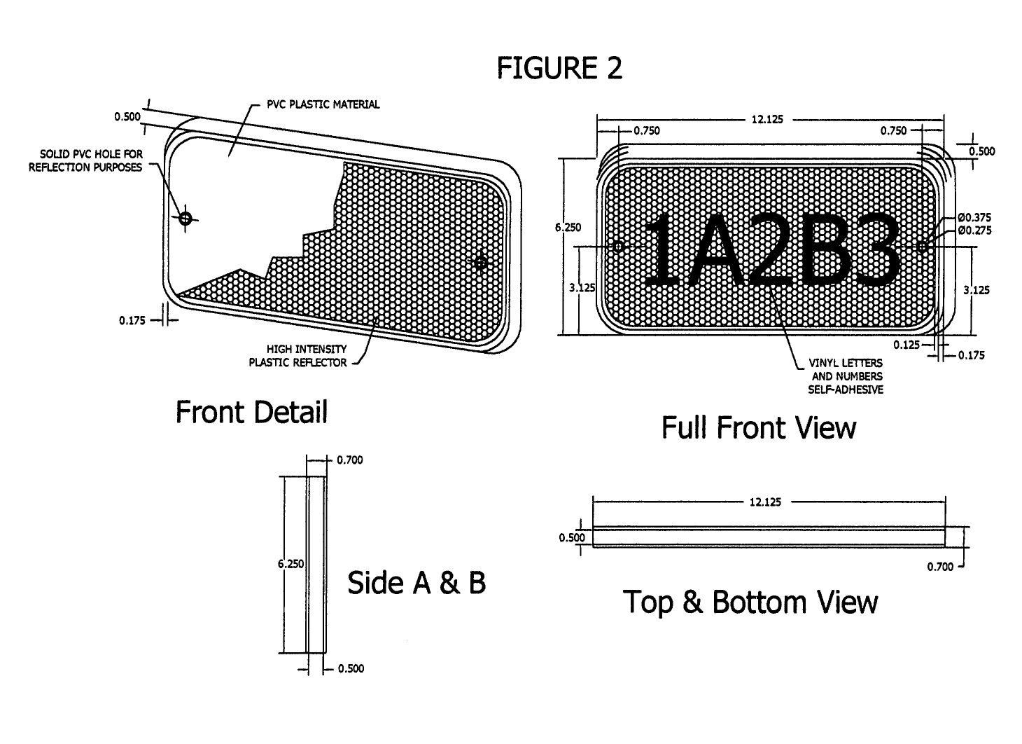

This figure illustrates a combination of FIG. 1, which is enhanced by adding the self-adhesive vinyl letters or numbers that will be specified by the consumer.

FIG. 3: PLASTIC SIDE MOUNTED HORIZONTAL REFLECTOR PLATE

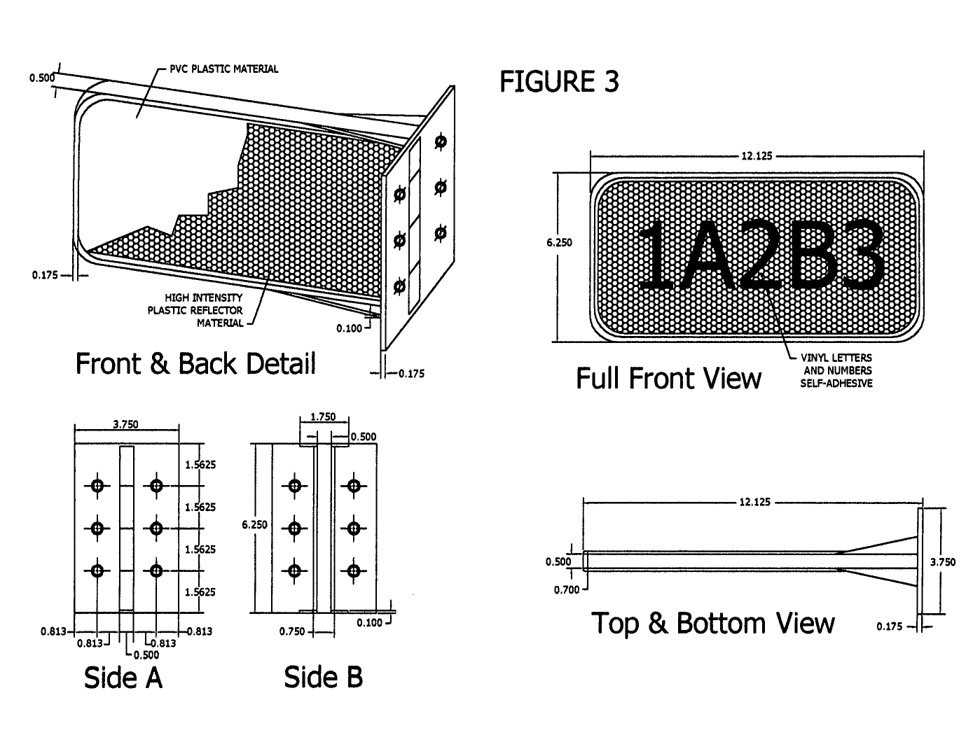

This figure illustrates a combination of FIG. 1 and FIG. 2 enhanced by adding a side-mounting feature which will allow two-sided, horizontally positioned views of the self-adhesive vinyl letters or numbers that will be specified by the consumer.

FIG. 4: PLASTIC SIDE MOUNTED VERTICAL REFLECTOR PLATE

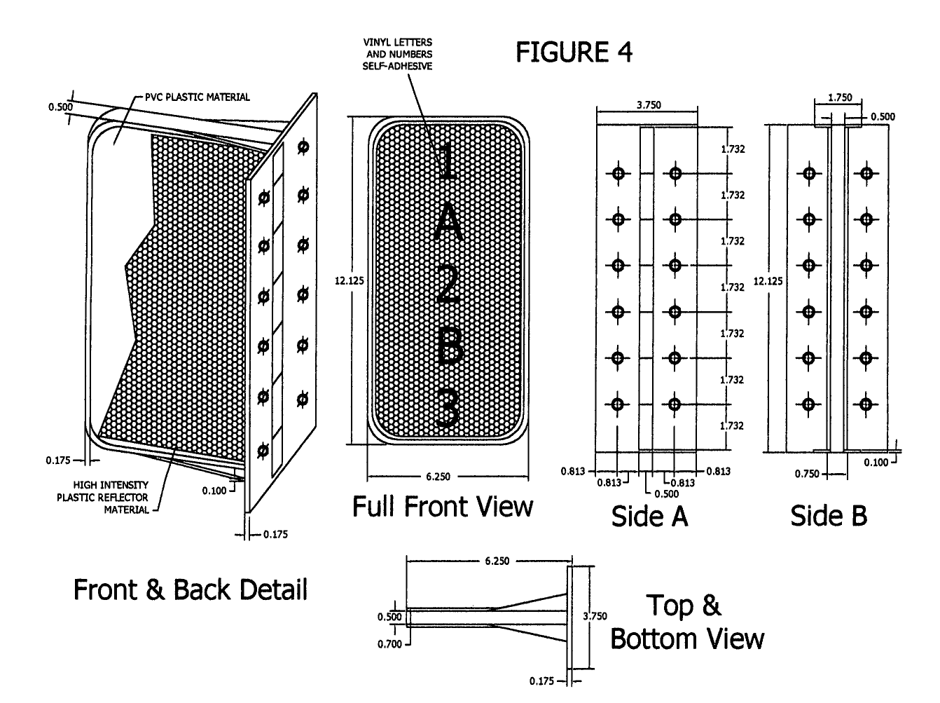

This figure illustrates a combination of FIG. 1 and FIG. 2 and is enhanced by adding a side-mounting feature to allow two-sided, vertically positioned views of the self-adhesive vinyl letters or numbers that will be specified by the consumer.

FIG. 5: PLASTIC LICENSE OR SIGN REFLECTOR PLATE

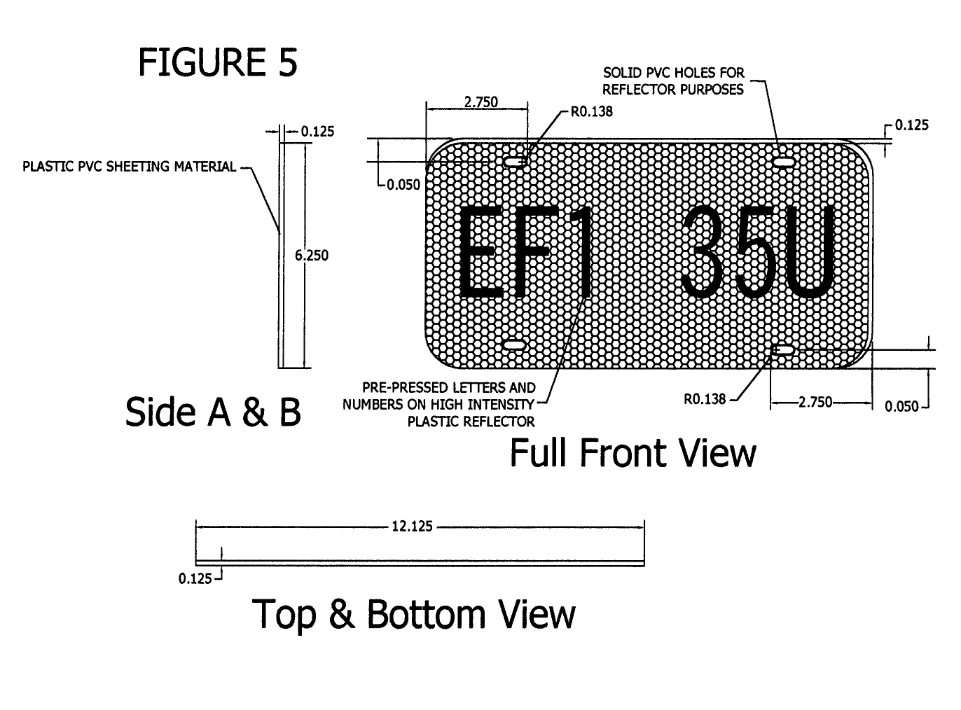

This figure illustrates a basic display system which shows the plastic PVC material bound or weld together with high intensity reflector plastic reflector which have assigned pre-pressed letters or numbers with four solid holes. The four solid holes enable installations.

1. The claims are as follows: First, a high intensity, plastic, reflective plate is comprised of a plastic reflector with a PVC or ALUMINUM backing for reflection when light from any source is directed toward the plate. The plates are made in different colors, such as amber, blue, green, red, and white and in various shapes, such as one-sided, two-sided, horizontal, or vertical. The various shapes provide easy mounting. Secondly, the plate is made to conform with standard vehicle license plates with pre-pressed letters and numbers attached to the plastic reflector. Finally, following production of the plate itself, adhesive vinyl numbers are laminated onto it as house numbers. The option for a one-sided or two-sided device is appropriate for directional visibility when the plate is mounted either on the wall of a house, or on mailboxes and roads.
